(19) United States
(12) Patent Application Publication
(10) Pub. No.: US 2018/0288402 A1
(43) Pub. Date: Oct. 4, 2018

(54) THREE-DIMENSIONAL DISPLAY CONTROL METHOD, THREE-DIMENSIONAL DISPLAY CONTROL DEVICE AND THREE-DIMENSIONAL DISPLAY APPARATUS

(71) Applicants: BOE TECHNOLOGY GROUP CO., LTD., Beijing (CN); HEFEI XINSHENG OPTOELECTRONICS TECHNOLOGY CO., LTD., Anhul (CN)

(72) Inventors: Huan NI, Beijing (CN); Xinxia Zhang, Beijing (CN); Xiao Guo, Beijing (CN); Feifei Zhu, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 15/833,346

(22) Filed: Dec. 6, 2017

(30) Foreign Application Priority Data
Mar. 30, 2017 (CN) 201710201820.0

(51) Int. Cl. H04N 13/32; H04N 13/383

(52) U.S. Cl. CPC H04N 13/32; H04N 13/383

(57) ABSTRACT

A 3D display control method, a 3D display control device and a 3D display apparatus are provided. The method includes: obtaining a left-eye location and a right-eye location of a user through a location detection module; and changing, through a light propagation direction control module, a light propagation direction of an image displayed on the display panel, to project a left-eye image to the left-eye location in a first duration of each display period and to project a right-eye image to the right-eye location in a second duration of each display period, where the first duration does not overlap with the second duration. The device includes a location detection module and a light propagation direction control module.

### CROSS-REFERENCE TO RELATED APPLICATION

This application claims priority to Chinese Patent Application No. 201710201820.0 filed on Mar. 30, 2017, which is incorporated herein by reference in its entirety.

### TECHNICAL FIELD

The present disclosure relates to the field of display technologies, and in particular, relates to a three-dimensional (3D) display control method, a 3D display control device and a 3D display apparatus.

### BACKGROUND

3D display can provide stereoscopic scene, which enhances viewing experience of a viewer. As 3D technology develops, the glasses-free 3D technology has come out. Glasses-free 3D displays are widely applied in various fields such as advertising, media business, demonstration teaching, exhibitions and film and television industry. Compared with binocular 3D display technology, the glasses-free 3D display enables a viewer to enjoy 3D effects without wearing glasses or a helmet. In addition, due to its vivid depth-of-field effect and stereoscopic effect, the glasses-free 3D display can provide the viewer with stronger visual impact and denser immersion during viewing; hence, the glasses-free 3D display becomes an excellent choice for production promotion, public propaganda and video playing.

The glasses-free 3D display is generally achieved by dividing, through a grating or an optical lens, an image displayed on a display such that two eyes of the viewer can see different images. According to different displaying principles and different optical structures, the glasses-free 3D display may include Parallax Barrier technique, Lenticular Arrays technique and Integral Imaging technique, which may cause different problems as follows during actual application. For Parallax Barrier technique, the display resolution is inversely proportional to the quantity of viewpoints and the brightness of the displayed image is relatively low. Lenticular Arrays technique is incompatible with current manufacturing process for liquid crystal display, and accordingly, the application of Lenticular Arrays technique results in higher cost. Integral Imaging technique, which is a true 3D display technique using micro-lens array to record and reconstruct a 3D scene, requires a complicated structure and high manufacture cost.

### SUMMARY

In view of the above, the present disclosure provides a 3D display control method, a 3D display control device and a 3D display apparatus, which may improve 3D display effect and reduce production cost.

In one aspect, a 3D display control method is provided according to some embodiments of the present disclosure. The 3D display control method is applied to control a display panel to perform a 3D display, including: obtaining a left-eye location and a right-eye location of a user through a location detection module; and changing, through a light propagation direction control module, a light propagation direction of an image displayed on the display panel, to project a left-eye image to the left-eye location in a first duration of each display period and to project a right-eye image to the right-eye location in a second duration of each display period, where the first duration does not overlap with the second duration.

Optionally, the first duration and the second duration form one display period.

Optionally, after the step of changing, through the light propagation direction control module, the light propagation direction of the image displayed on the display panel, the 3D display control method further includes: detecting, through the location detection module, changes of the left-eye location and the right-eye location and obtaining, through the location detection module, a new left-eye location and a new right-eye location; and changing, through the light propagation direction control module, a light propagation direction of an image displayed on the display panel, to project a left-eye image to the new left-eye location in the first duration of each display period and to project a right-eye image to the new right-eye location in the second duration of each display period.

Optionally, the light propagation direction control module includes a liquid crystal cell. The step of changing, through the light propagation direction control module, the light propagation direction of the image displayed on the display panel includes: changing a voltage applied to two sides of the liquid crystal cell, to adjust deflection angles of liquid crystals in the liquid crystal cell and change the light propagation direction of the displayed image.

In another aspect, a 3D display control device is provided according to some embodiments of the present disclosure. The 3D display control device includes: a location detection module, used to obtain a left-eye location and a right-eye location of a user; and a light propagation direction control module, used to change a light propagation direction of an image displayed on the display panel, to project a left-eye image to the left-eye location in a first duration of each display period and to project a right-eye image to the right-eye location in a second duration of each display period, where the first duration does not overlap with the second duration.

Optionally, the first duration and the second duration form one display period.

Optionally, the location detection module is further used to detect changes of the left-eye location and the right-eye location and obtain a new left-eye location and a new right-eye location; and the light propagation direction control module is further used to change a light propagation direction of an image displayed on the display panel, to project a left-eye image to the new left-eye location in the first duration of each display period and to project a right-eye image to the new right-eye location in the second duration of each display period.

Optionally, the light propagation direction control module includes: a liquid crystal cell; and a voltage adjusting unit, used to change a voltage applied to two sides of the liquid crystal cell to adjust deflection angles of liquid crystals in the liquid crystal cell and change the light propagation direction of the displayed image.

Optionally, the display panel includes multiple pixel units, the liquid crystal cell includes a first substrate, a second substrate, multiple electrode units and a liquid crystal layer arranged between the first substrate and the second substrate. The multiple electrode units are arranged corresponding to the multiple pixel units of the display panel, and each of the multiple electrode units includes two electrodes that are respectively arranged at a side of the first substrate close to the liquid crystal layer and a side of the second substrate close to the liquid crystal layer.

In another aspect, a 3D display apparatus is provided according to some embodiments of the present disclosure, including a display panel and any of the above-mentioned 3D display control device. The light propagation direction control module is provided at a light-emitting side of the display panel.

Optionally, the location detection module includes an infrared sensor arranged at the display panel.

Optionally, the infrared sensor includes an infrared detection element provided outside the display panel or includes a sensing element provided inside the display panel and made of an infrared phosphor.

In view of the above, with the 3D display control method, the 3D display control device and the 3D display apparatus according to the embodiments of the present disclosure, the left-eye image and the right-eye image can be respectively projected to the left-eye location and the right-eye location, thereby achieving 3D effect. Both the left-eye image and the right-eye image can be displayed by all pixels of the display panel; hence, the display performance may not be decreased. According to the embodiments of the present disclosure, changes of the locations of the two eyes can be detected in real-time and the image can be displayed with the optimal viewing angle. The light propagation direction is controlled by the liquid crystal cell, so the cost may not be greatly increased while achieving good display effect.

### BRIEF DESCRIPTION OF THE DRAWINGS

FIG. 1 is a flowchart of a 3D display control method according to some embodiments of the present disclosure;

FIG. 2 is a schematic structural block diagram of a 3D display control device according to some embodiments of the present disclosure;

FIG. 3 is a schematic structural diagram of a display apparatus according to some embodiments of the present disclosure;

FIG. 4 is a schematic structural diagram of a liquid crystal cell of a display apparatus according to some embodiments of the present disclosure;

FIG. 5 schematically illustrates projection of left-eye view by a display apparatus according to some embodiments of the present disclosure; and

FIG. 6 schematically illustrates projection of right-eye view by a display apparatus according to some embodiments of the present disclosure.

### DETAILED DESCRIPTION

For clarifying technical solutions and advantages of the present disclosure, detailed description is given based on embodiments in conjunction with drawings.

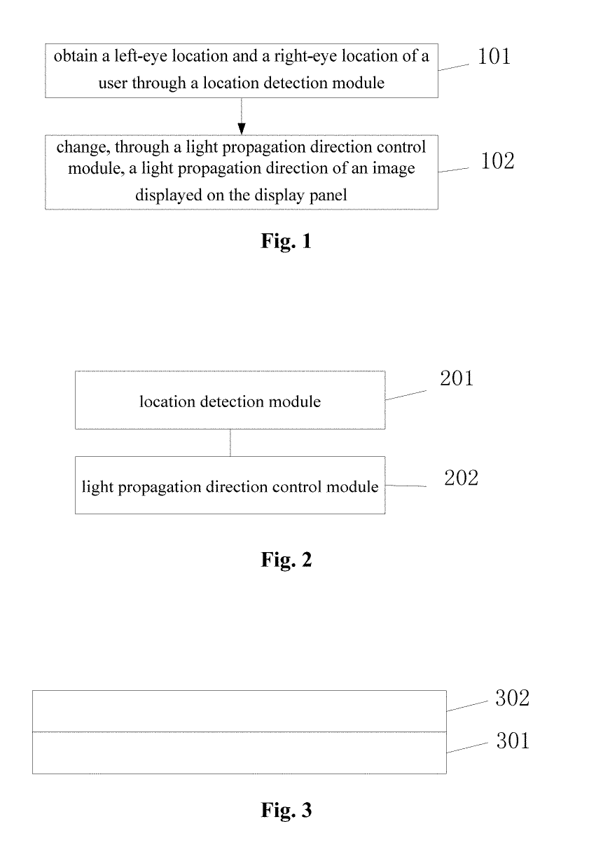

A 3D display control method is provided according to some embodiments of the present disclosure. The 3D display control method is applied to control a display panel to perform 3D display and, as shown in FIG. 1, includes following steps. Step 101 is to obtain a left-eye location and a right-eye location of a user through a location detection module. Step 102 is to change, through a light propagation direction control module, a light propagation direction of an image displayed on the display panel, to project a left-eye image to the left-eye location 501 as shown in FIG. 5 in a first duration of each display period and to project a right-eye image to the right-eye location 601 as shown in FIG. 6 in a second duration of each display period. Here, the first duration does not overlap with the second duration.

In view of the above, with the 3D display control method according to the embodiments of the present disclosure, the left-eye image and the right-eye image can be respectively projected based on the left-eye location and the right-eye location, and pixels of the display are not divided for displaying the left-eye image and the right-eye image respectively, that is, as shown in FIGS. 5 and 6, both the left-eye image and the right-eye image are displayed by all pixels of the display in a time-division way. By successively displaying the left-eye image and the right-eye image through all RGB pixels of the display panel, both the left-eye image and the right-eye image can be displayed with relatively high image quality. Furthermore, the 3D display control method according to the embodiments of the present disclosure does not require any complicated light path changing mechanism and may not greatly increase production cost of a display apparatus, and a best viewing location can be optimized by projecting the left-eye image and the right-eye image based on locations of the eyes.

According to some embodiments of the present disclosure, an alternating frequency of the left-eye image and the right-eye image is not lower than a minimum identification frequency of human eyes. For example, in the case that one frame of left-eye image is displayed in the first duration and one frame of right-eye image is displayed in the second duration, an image displaying frequency is twice the minimum identification frequency of the human eyes; in the case that two frame of left-eye images are continuously displayed in the first duration and two frames of right-eye images are continuously displayed in the second duration, the image displaying frequency is four times the minimum identification frequency of the human eyes.

According to some embodiments of the present disclosure, the location detection module may include a module that obtains locations of two eyes through a light detection signal (such as an infrared detection signal), ultrasonic wave detection signal or the like.

For example, the location detection module includes a camera element used to take an image of a face of a user utilizing a display apparatus, and an image analyzing unit used to analyze the image of the face of the user to obtain locations of two eyes of the user.

For another example, the location detection module includes an infrared detector used to obtain an infrared spectrogram of the face of the user, and an infrared analyzing unit used to analyze the infrared spectrogram of the face of the user to obtain locations of two eyes of the user.

For another example, the location detection module includes an ultrasonic detector used to emit ultrasonic wave and obtain ranges of densities at different parts of the face of the user, and an ultrasonic analyzing unit used to compare a preset range of a density at two eyes with the obtained ranges of densities at different parts of the face of the user to obtain locations of the two eyes. Optionally, the preset range of the density at the two eyes may be determined based on statistical analysis on ranges of densities at two eyes of a number of human beings.

Practically, there may exist faces of many persons in a detecting range of the location detection module, so the location detection module may detect many pairs of eyes. To ensure that viewing of the user utilizing the 3D display apparatus is not interfered by other persons in the detecting range, the location detection module, in case of detecting the face of more than one person, executes the following steps: obtain, through the location detection module, a relative area of a face of the more than one person in the detecting range and a relative location of the face of the more than one person with respect to the location detection module; identify a face whose relative location is within a preset range and whose relative area is larger than a preset value as the face of the user utilizing the display apparatus; and analyze the face of the user to obtain locations of two eyes of the user.

The relative area of the face of a person reflects a distance from the face to the location detection module. In case of not considering differences among actual areas of different persons, the closer the face to the location detection module, the larger the relative area of the face. The relative location of the face with respect to the location detection module reflects whether the face is located in a viewing range of the display apparatus or not. For example, in the case that an angle between a segment from a center of the face to a center of the location detection module and a normal vector of a screen of the display apparatus is smaller than or equal to a certain angle, it is indicated that the face is located within the viewing range of the display apparatus; otherwise, it is indicated that the face is beyond the viewing range of the display apparatus, so the face does not belong to the current user of the display apparatus and it is detected only because of being located within the detection range of the location detection module.

According to some embodiments of the present disclosure, the first duration and the second duration form one display period. By successively projecting left-eye images and right-eye images to the left-eye location and the right-eye location in multiple display periods, those continuously played images may present a continuous 3D scene to the user.

Optionally, each of the first duration and the second duration equals to a duration for playing one frame of image, one frame of left-eye image is played in the first duration and one frame of right-eye image is played in the second duration. In this case, with the method according to the embodiments of the present disclosure, one frame of right-eye image is played after one frame of left-eye image, and one frame of left-eye image is played after one frame of right-eye image, and so forth, thereby presenting a 3D scene in a viewing range of the two eyes.

According to some embodiments of the present disclosure, each of the first duration and the second duration may equal to a duration for playing at least one frame of image, that is, at least one frame of left-eye image is played in the first duration and at least one frame of right-eye image is played in the second duration. In this case, a displaying frequency of the left-eye image and the right-eye image is required to reach a certain value such that the left eye or the right eye may not observe image flickering and the viewing effect may not be adversely affected.

According to some embodiments of the present disclosure, after the step of changing, through the light propagation direction control module, the light propagation direction of the image displayed on the display panel, the method further includes: detecting, through the location detection module, changes of the left-eye location and the right-eye location and obtaining, through the location detection module, a new left-eye location and a new right-eye location; and changing, through the light propagation direction control module, a light propagation direction of an image displayed on the display panel, to project a left-eye image to the new left-eye location in the first duration of each display period and to project a right-eye image to the new right-eye location in the second duration of each display period.

When watching the display apparatus practically, locations of two eyes of the user may change. According to the above embodiments of the present disclosure, it is detected in real-time or periodically during a watching process whether locations of two eyes of the user change or not, thereby being in accordance with watching habit of the user, optimizing the viewing location in real-time and preventing change of displaying effect due to changed locations of eyes of the user.

According to some embodiments of the present disclosure, the light propagation direction control module may include a liquid crystal cell. The step of changing, through the light propagation direction control module, the light propagation direction of the image displayed on the display panel may include: changing a voltage applied to two sides of the liquid crystal cell, to adjust deflection angles of liquid crystals in the liquid crystal cell and change the light propagation direction of the displayed image. By controlling the light propagation direction using the liquid crystal cell, the manufacturing cost is relatively low, and the operation is simple since the light propagation can be controlled by controlling the voltage.

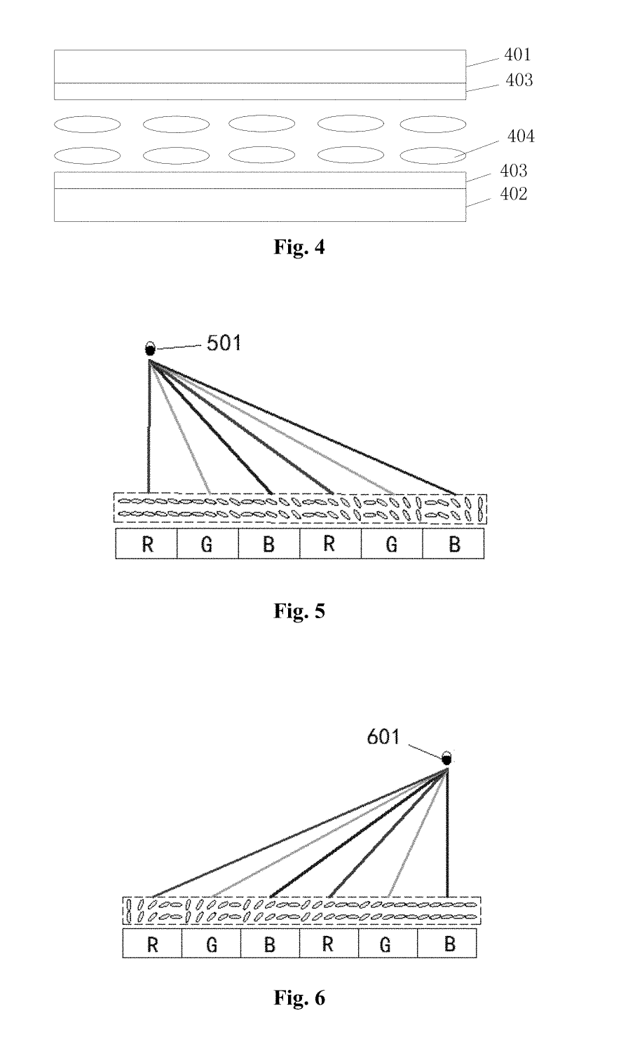

According to some embodiments of the present application, the display panel includes multiple pixel units. As shown in FIG. 4, the liquid crystal cell includes a first substrate 401 and a second substrate 402 arranged opposite to each other; electrodes 403 and liquid crystals 404 are provided between the first substrate 401 and the second substrate 402. Multiple electrode units are provided in the liquid crystal cell. The multiple electrode units are arranged corresponding to the multiple pixel units. Each electrode unit includes two electrodes which are respectively arranged at a side of the first substrate close to the liquid crystal layer and a side of the second substrate close to the liquid crystal layer. During a displaying process, by controlling the respective electrode units, deflection directions of the liquid crystals 404 between the two electrodes of each electrode unit can be changed, and accordingly propagation directions of lights emitted through the liquid crystal cell are changed.

According to some embodiments of the present application, the liquid crystal cell may include a variable-refractive index liquid crystal cell. Optically, the variable-refractive index liquid crystal cell may include a birefringence liquid crystal cell. Optionally, birefringence liquid crystals may include nematic liquid crystals (NLCs). Since the NLC has a birefringence characteristic, a light entered the liquid crystal may be refracted due to two refractive indexes into a light o whose polarization direction is perpendicular to an optical axis and a light e whose polarization direction is in parallel with the optical axis. Speeds of the light o and light e are different. The speed is inversely proportional to the refractive index. In the case that the speed of the light e is smaller than the speed of the light o, a refractive index Ne of the light e is larger than a refractive index No of the light o, that is to say, Ne-No is larger than 0, so the birefringence is larger than 0. In the case that speed of the light e is larger than the speed of the light o, Ne-No is smaller than 0, so the birefringence is smaller than 0. The variable-refractive index liquid crystal cell controls orientations of the liquid crystals using different electric fields, a horizontal axis direction and a vertical axis direction of each pixel correspond to different refractive indexes, and light of the pixel is refracted to a corresponding angle, such that the left-eye image is projected to the left-eye location and the right-eye image is projected to the right-eye location.

According to some other embodiments of the present disclosure, the liquid crystal cell may use normal liquid crystals since they also can change emitting angles of lights.

In the embodiments of the present disclosure, the liquid crystal cell is used to control the light propagation direction. When it is required to achieve the 3D display, the light propagation direction is changed such that left-eye images and right-eye images are respectively projected to the left eye and the right eye. When the 3D display is not required, the liquid crystal cell may be controlled by the electric fields such that deflection directions of the liquid crystals may not affect the light propagation direction, thereby achieving 2D display. In this case, the 3D display control method further includes: receiving a 2D display instruction; changing a state of the light propagation direction control module according to the 2D display instruction, to enable the light propagation direction of the image displayed on the display panel to be unaffected by the light propagation direction control module.

The method provided in the above embodiments of the present disclosure can be applied to a hardware having an information and signal processing function, such as a processor. The processor may be an integrated circuit chip and may include a central processing unit or a microprocessor. Practically, steps of the method may be implemented by an integrated logic circuit in the hardware processor or may be implemented by software instructions. The central processing unit may include a general processor, a digital signal processor, an application specific integrated circuit, a field programmable gate array or other programmable logic component, discrete gate, transistor logic component, discrete hardware assembly that can achieve the methods according to the embodiments of the present disclosure and execute the steps of the methods.

In another aspect, a 3D display control device is provided in the present disclosure, which is used to control a display panel to perform 3D display.

As shown in FIG. 2, the 3D display control device includes: a location detection module 201, used to obtain a left-eye location and a right-eye location of a user; and a light propagation direction control module, used to change a light propagation direction of an image displayed on the display panel, to project a left-eye image to the left-eye location in a first duration of each display period and to project a right-eye image to the right-eye location in a second duration of each display period. Here, the first duration does not overlap with the second duration.

In view of the above, with the 3D display control device according to the embodiments of the present disclosure, the left-eye image and the right-eye image can be respectively projected based on the left-eye location and the right-eye location, the left eye of the user receives a left-eye view and the right eye receives a right-eye view in different durations, and left-eye view and the right-eye view forms a 3D scene. When performing 3D display with the 3D display control device according to the embodiments of the present disclosure, there is no need to divide all pixels of the display panel for displaying the left-eye image and the right-eye image, instead, both the left-eye image and the right-eye image are displayed by all pixels in a display region of the display panel; hence, the displayed image can be ensured with high resolution and high brightness. Compared with the glasses-free 3D display apparatus in related technology, the 3D display control device according to the embodiments of the present disclosure can provide better 3D display effect.

According to some embodiments of the present disclosure, the first duration and the second duration form one display period.

According to some embodiments of the present disclosure, the location detection module is further used to detect changes of the left-eye location and the right-eye location and obtain a new left-eye location and a new right-eye location. The light propagation direction control module is further used to change a light propagation direction of an image displayed on the display panel, to project a left-eye image to the new left-eye location in the first duration of each display period and to project a right-eye image to the new right-eye location in the second duration of each display period.

According to some embodiments of the present disclosure, the light propagation direction control module may include a liquid crystal cell. The light propagation direction control module includes a voltage adjusting unit, used to change a voltage applied to two sides of the liquid crystal cell to adjust deflection angles of liquid crystals in the liquid crystal cell and change the light propagation direction of the displayed image.

It is understood by those skilled in the art that the 3D display control device according to the embodiments of the present disclosure can be achieved by electronic hardware, computer software or combination thereof. Whether functions of the 3D display control device are accomplished by hardware or software depends on specific applications of the technical solution and design restrictions. For different specific applications, the ordinary skilled in the art may achieve the functions in different manners, which all fall within protection scope of the present disclosure.

In addition, a 3D display apparatus is provided in the present disclosure. FIG. 3 is a schematic structural diagram of the 3D display apparatus. The 3D display apparatus includes a display panel 301 and the 3D display control device according any forgoing embodiment of the present disclosure. The light propagation direction control module 302 of the 3D display control device is provided at a light-emitting side of the display panel 301.

In view of the above, with the 3D display apparatus according to the embodiments of the present disclosure, the left-eye image and the right-eye image can be respectively projected to the left-eye location and the right-eye location during 3D display, there is no need to divide pixels of the display panel for displaying the left-eye image and the right-eye image; hence, the displayed image can be ensured with high resolution and high brightness. The 3D display apparatus according to the embodiments of the present disclosure can provide better 3D viewing experience to the user.

According to some embodiments of the present disclosure, the location detection module includes an infrared sensor provided at the display apparatus. Locations of two eyes can be accurately detected by the infrared sensor. Since infrared detection techniques are very mature now, the cost and complexity in applying the infrared detection techniques are very low.

According to some embodiments of the present disclosure, the infrared sensor may include an infrared detection element provided outside the display panel, or may include a sensing element provided inside the display panel and made of an infrared phosphor. A light guide plate of a backlight module may be doped with the infrared phosphor, or the display panel is doped with the infrared phosphor.

In view of the above, with the 3D display control method, the 3D display control device and the 3D display apparatus according to the embodiments of the present disclosure, the left-eye image and the right-eye image can be respectively projected to the left-eye location and the right-eye location, thereby achieving 3D effect. Both the left-eye image and the right-eye image can be displayed by all pixels of the display panel; hence, the display performance may not be decreased. According to the embodiments of the present disclosure, changes of the locations of the two eyes can be detected in real-time and the image can be displayed with the optimal viewing angle. The light propagation direction is controlled by the liquid crystal cell, so the cost may not be greatly increased while achieving good display effect.

It should be noted that the embodiments described in the specification are intended to explain and clarify the present disclosure, rather than to limit the present disclosure. In case of no confliction, embodiments and characters in the embodiments can be combined.

Obviously, the ordinary skilled in the art may make various changes and variations to the present disclosure without departing from the mind and scope of the present disclosure. The present disclosure intends to include all these changes and variations if they fall within the scope defined by claims of the present disclosure or equivalent techniques.

What is claimed is:

1. A three-dimensional (3D) display control method, applied to control a display panel to perform a 3D display, comprising:
obtaining a left-eye location and a right-eye location of a user through a location detection module; and
changing, through a light propagation direction control module, a light propagation direction of an image displayed on the display panel, to project a left-eye image to the left-eye location in a first duration of each display period and to project a right-eye image to the right-eye location in a second duration of each display period, wherein the first duration does not overlap with the second duration.

2. The 3D display control method according to claim 1, wherein the first duration and the second duration form one display period.

3. The 3D display control method according to claim 1, wherein after the step of changing, through the light propagation direction control module, the light propagation direction of the image displayed on the display panel, the 3D display control method further comprises:
detecting, through the location detection module, changes of the left-eye location and the right-eye location and obtaining, through the location detection module, a new left-eye location and a new right-eye location; and
changing, through the light propagation direction control module, a light propagation direction of an image displayed on the display panel, to project a left-eye image to the new left-eye location in the first duration of each display period and to project a right-eye image to the new right-eye location in the second duration of each display period.

4. The 3D display control method according to claim 1, wherein the light propagation direction control module comprises a liquid crystal cell, and
the step of changing, through the light propagation direction control module, the light propagation direction of the image displayed on the display panel comprises: changing a voltage applied to two sides of the liquid crystal cell, to adjust deflection angles of liquid crystals in the liquid crystal cell and change the light propagation direction of the displayed image.

5. A three-dimensional (3D) display control device, applied to control a display panel to perform a 3D display, comprising:
a location detection module, configured to obtain a left-eye location and a right-eye location of a user; and
a light propagation direction control module, configured to change a light propagation direction of an image displayed on the display panel, to project a left-eye image to the left-eye location in a first duration of each display period and to project a right-eye image to the right-eye location in a second duration of each display period, wherein the first duration does not overlap with the second duration.

6. The 3D display control device according to claim 5, wherein the first duration and the second duration form one display period.

7. The 3D display control device according to claim 5, wherein the location detection module is further configured to detect changes of the left-eye location and the right-eye location and obtain a new left-eye location and a new right-eye location; and
the light propagation direction control module is further configured to change a light propagation direction of an image displayed on the display panel, to project a left-eye image to the new left-eye location in the first duration of each display period and to project a right-eye image to the new right-eye location in the second duration of each display period.

8. The 3D display control device according to claim 5, wherein the light propagation direction control module comprises:
a liquid crystal cell; and
a voltage adjusting unit, configured to change a voltage applied to two sides of the liquid crystal cell to adjust deflection angles of liquid crystals in the liquid crystal cell and change the light propagation direction of the displayed image.

9. The 3D display control device according to claim 8, wherein the display panel comprises a plurality of pixel units, the liquid crystal cell comprises a first substrate, a second substrate, a plurality of electrode units and a liquid crystal layer arranged between the first substrate and the second substrate;
the plurality of electrode units is arranged corresponding to the plurality of pixel units of the display panel, and each of the plurality of electrode units includes two electrodes that are respectively arranged at a side of the first substrate close to the liquid crystal layer and a side of the second substrate close to the liquid crystal layer.

10. A three-dimensional (3D) display apparatus, comprising a display panel and a 3D display control device,
wherein the 3D display control device is applied to control the display panel to perform a 3D display and comprises:
a location detection module, configured to obtain a left-eye location and a right-eye location of a user; and
a light propagation direction control module, configured to change a light propagation direction of an image displayed on the display panel, to project a left-eye image to the left-eye location in a first duration of each display period and to project a right-eye image to the right-eye location in a second duration of each display period, wherein the first duration does not overlap with the second duration; and
wherein the light propagation direction control module is provided at a light-emitting side of the display panel.

11. The 3D display apparatus according to claim 10, wherein the location detection module comprises an infrared sensor arranged at the display panel, the infrared sensor comprises an infrared detection element provided outside the display panel or comprises a sensing element provided inside the display panel and made of an infrared phosphor.

12. The 3D display apparatus according to claim 10, wherein the first duration and the second duration form one display period.

13. The 3D display apparatus according to claim 10, wherein the location detection module is further configured to detect changes of the left-eye location and the right-eye location and obtain a new left-eye location and a new right-eye location; and
the light propagation direction control module is further configured to change a light propagation direction of an image displayed on the display panel, to project a left-eye image to the new left-eye location in the first duration of each display period and to project a right-eye image to the new right-eye location in the second duration of each display period.

14. The 3D display apparatus according to claim 10, wherein the light propagation direction control module comprises:
a liquid crystal cell; and
a voltage adjusting unit, configured to change a voltage applied to two sides of the liquid crystal cell to adjust deflection angles of liquid crystals in the liquid crystal cell and change the light propagation direction of the displayed image.

15. The 3D display apparatus according to claim 14, wherein the display panel comprises a plurality of pixel units, the liquid crystal cell comprises a first substrate, a second substrate, a plurality of electrode units and a liquid crystal layer arranged between the first substrate and the second substrate;
the plurality of electrode units is arranged corresponding to the plurality of pixel units of the display panel, and each of the plurality of electrode units includes two electrodes that are respectively arranged at a side of the first substrate close to the liquid crystal layer and a side of the second substrate close to the liquid crystal layer.
